(19) United States
(12) Patent Application Publication
(10) Pub. No.: US 2022/0265389 A1
(43) Pub. Date: Aug. 25, 2022

(54) DENTAL WEDGE

(71) Applicant: Garrison Dental Solutions, L.L.C., Spring Lake, MI (US)

(72) Inventors: Joel Wessely, Comstock Park, MI (US); Robert W. Anderson, Spring Lake, MI (US)

(21) Appl. No.: 17/673,202

(22) Filed: Feb. 16, 2022

Related U.S. Application Data
(60) Provisional application No. 63/153,673, filed on Feb. 25, 2021.

(51) Int. Cl. A61C 5/88

(52) U.S. Cl. CPC A61C 5/88

(57) ABSTRACT

A dental wedge is provided to facilitate separating adjacent teeth and supporting a band during a filling process. The dental wedge includes an elongate body having a distal end and a proximal end tapering to the distal end. The elongate body may include an inside surface and an outside surface opposite the inside surface that extend from the proximal end to the distal end. The inside surface is configured to support a matrix band in contact with a tooth surface of a working tooth, and the outside surface including a base surface and a rib that protrudes from the base surface away from the inside surface.

### FIELD OF INVENTION

The present disclosure relates to a wedge and, more particularly, to a dental wedge used in dental restoration.

### BACKGROUND

If a decayed portion of a tooth is located near its interproximal area, the tooth structure itself is usually insufficient to provide support to the filling material during the filling process. In order to retain the filling material in an excavated cavity, while the filling material hardens, a band is conventionally positioned about the tooth and secured tightly about the tooth so that the band forms an outer shell or matrix. In addition, it is often necessary to separate the adjacent teeth so that the filling material when hardened will provide adequate contact between the teeth to restore the teeth to their original state.

To separate teeth and, further, to hold the band in place, dentists often use a wedge typically formed from wood or plastic. The wedge is inserted in the interproximal area or space between the adjacent teeth at the gum line. When forced into the space, the wedge causes the teeth to separate and, further, seals the band against the tooth to retain the filling material in the cavity and to prevent overhang of the filling material in the interproximal area.

Conventional wedges are tetrahedral in shape and tend to have relatively sharp edges. This style of conventional wedge can fail to maintain sufficient contact between the band and the tooth during the filling process, largely because the tetrahedral shape of the wedge fails to make sufficient contact with the band and a tooth adjacent to the tooth being filled. As result, irregularities, such as overhangs, are a regular occurrence with conventional wedges, and can lead to further or premature decay.

Additionally, the sharp edges can aggravate the gum tissue of the tooth being filled. Conventional wedges are constructed so that when placed or forced into the interproximal space they also have a tendency to shift horizontally or slightly downward due to the contact between the wedge and the teeth. This can induce bleeding, and if the wedge is forced thru the interproximal space, a pointed wedge could either be driven into or through the gum tissue that surrounds the tooth (e.g., the sulcus). The result is the patient often experiences some discomfort, and the dentist is inhibited from performing a proper restoration.

### SUMMARY

A dental wedge is provided to facilitate separating adjacent teeth and supporting a band during a filling process. The dental wedge includes an elongate body having a distal end and a proximal end tapering to the distal end. The elongate body may include an inside surface and an outside surface opposite the inside surface that extend from the proximal end to the distal end. The inside surface is configured to support a matrix band in contact with a tooth surface of a working tooth, and the outside surface including a base surface and a rib that protrudes from the base surface away from the inside surface.

In one embodiment, a dental wedge is provided with an elongate body. The elongate body may include a distal end and a proximal end tapering to the distal end. The distal end may define an insertion end for inserting into an interproximal area between adjacent teeth. The elongate body may include a first portion starting at the distal end, a second portion ending at the proximal end, and an intermediate portion between the first portion and the second portion. The elongate body may include an inside surface that extends along the first, second, and intermediate portions, and may include an outside surface opposite the inside surface that extends along the first, second, and intermediate portions. The inside surface is configured to support a matrix band in contact with a tooth surface of a working tooth.

The outside surface of the elongate body may include a base surface and a ridge that protrudes from the base surface away from the inside surface. The ridge may extend along at least a portion of the elongate body between the distal end and the proximal end.

In one embodiment, the ridge is defined by a rib that is normal to the base surface and extends along the elongate body from the distal end to the proximal end. As an example, a cross-section of the intermediate portion is a substantially T-shaped structure with the rib defining a base of the substantially T-shaped structure.

In one embodiment, the inside surface of the dental wedge joins the outside surface at an upper portion and a lower portion of the elongate body. The lower portion and the upper portion extend from the distal end to the proximal end of the elongate body. The inside surface includes a primary surface disposed between the upper portion and the lower portion.

In one embodiment, the primary surface is substantially flat from the upper portion to the lower portion and curved from the distal end to the proximal end.

In one embodiment, the lower portion is rounded between the inside surface and the outside surface. The thickness of the lower portion may be sufficiently thin to wedge between the working tooth and gum tissue of the working tooth in response to placement of the elongate body between the working tooth and a tooth adjacent to the working tooth.

In one embodiment, a dental wedge is provided with an elongate body having a distal end and a proximal end tapering to the distal end. The distal end may define an insertion end for inserting into an interproximal area between adjacent teeth. The elongate body may include an inside surface and an outside surface opposite the inside surface. The outside surface may include a base surface and a protrusion that extends from the base surface away from the inside surface for at least a portion of the elongate body between the distal end and the proximal end.

In one embodiment, the protrusion defines a rib that is normal to the base surface and extends along the portion of the elongate body between the distal end to the proximal end. For instance, a cross-section of the portion is a substantially T-shaped structure with the rib defining a base of the substantially T-shaped structure.

In one embodiment, the inside surface may include a primary surface that is substantially flat from an upper portion to a lower portion of the elongate body and curved from the distal end to the proximal end.

The lower portion may be rounded between the inside surface and the outside surface, and a thickness of the lower portion may be sufficiently thin to slide between a working tooth and gum tissue of the working tooth in response to placement of the elongate body between the working tooth and a tooth adjacent to the working tooth.

In one embodiment, a dental wedge is provided with an elongate body having a distal end and a proximal end tapering to the distal end. The distal end may define an insertion end for inserting into an interproximal area between adjacent teeth. The elongate body may include an inside surface and an outside surface opposite the inside surface. The elongate body may include an upper portion and a lower portion extending from the distal end to the proximal end, with the inside surface joining the outside surface at the upper portion and the lower portion. The inside surface may include a primary surface disposed between the upper portion and the lower portion, and the outside surface may include a base surface and a rib that extends from the base surface away from the inside surface for at least a portion of the elongate body between the distal end and the proximal end.

In one embodiment, the upper portion and the lower portion may have thicknesses sufficiently thin to slide between a working tooth and gum tissue of the working tooth in response to placement of the elongate body between the working tooth and a tooth adjacent to the working tooth.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 shows a perspective view of a dental wedge in accordance with one embodiment of the present disclosure.

FIG. 2 shows a top view of the dental wedge of FIG. 1.

FIG. 3 shows a rear view of the dental wedge of FIG. 1.

FIG. 4 shows a right view of the dental wedge of FIG. 1.

FIG. 5 shows a partial view of FIG. 3.

FIG. 6 shows a sectional view of FIG. 2.

FIG. 7 shows a perspective view of a dental wedge in accordance with one embodiment of the present disclosure.

FIG. 8 shows a top view of the dental wedge of FIG. 7.

FIG. 9 shows a rear view of the dental wedge of FIG. 7.

FIG. 10 shows a right view of the dental wedge of FIG. 7.

FIG. 11 shows a partial view of FIG. 9.

FIG. 12 shows a sectional view of FIG. 8.

FIG. 13 shows a perspective view of a dental wedge in accordance with one embodiment of the present disclosure

FIG. 14 shows a top view of the dental wedge of FIG. 13.

FIG. 15 shows a rear view of the dental wedge of FIG. 13.

FIG. 16 shows a right view of the dental wedge of FIG. 13.

FIG. 17 shows a partial view of FIG. 15.

FIG. 18 shows a sectional view of FIG. 16.

FIG. 19 shows a perspective view of a dental wedge in accordance with one embodiment of the present disclosure.

FIG. 20 shows a top view of the dental wedge of FIG. 19.

FIG. 21 shows a rear view of the dental wedge of FIG. 19.

FIG. 22 shows a right view of the dental wedge of FIG. 19.

FIG. 23 shows a partial view of FIG. 21.

FIG. 24 shows a sectional view of FIG. 22.

### DETAILED DESCRIPTION

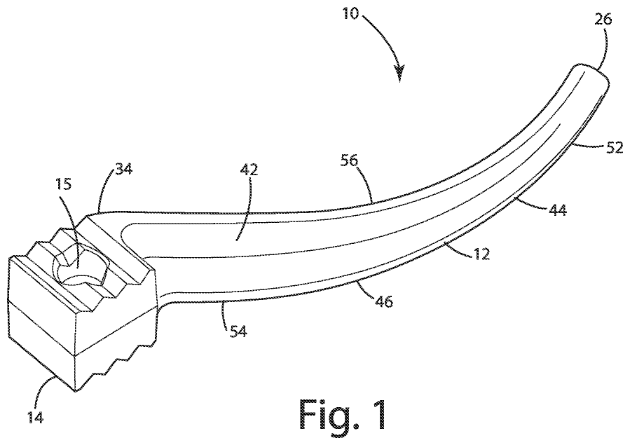

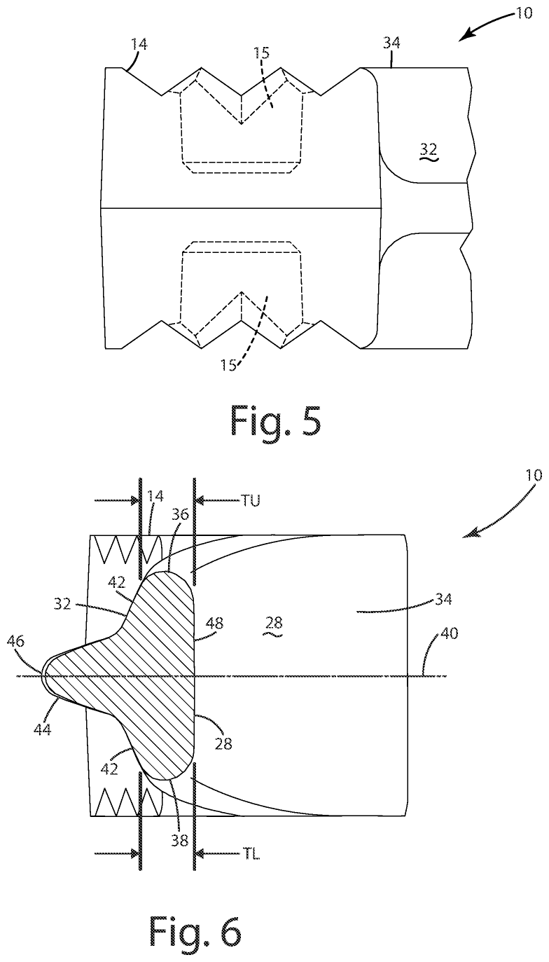

Referring to FIGS. 1-6, the numeral 10 generally designates a dental wedge in accordance with one embodiment. As will be more fully described herein, dental wedge 10 is configured to avoid significant trauma to the gum tissue when the dental wedge 10 is inserted between teeth while providing a wedge that exhibits reduced slippage after insertion between the adjacent teeth.

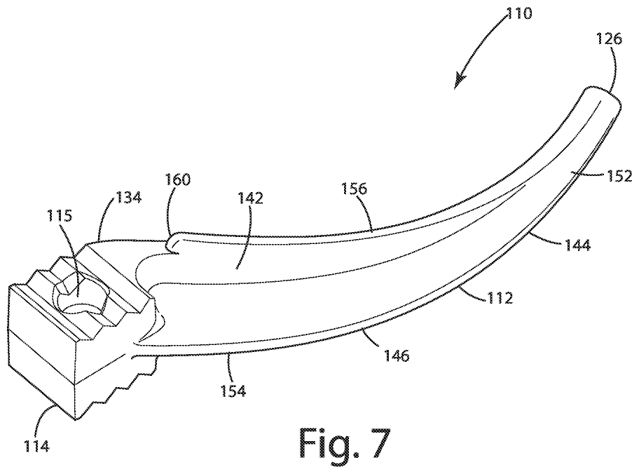

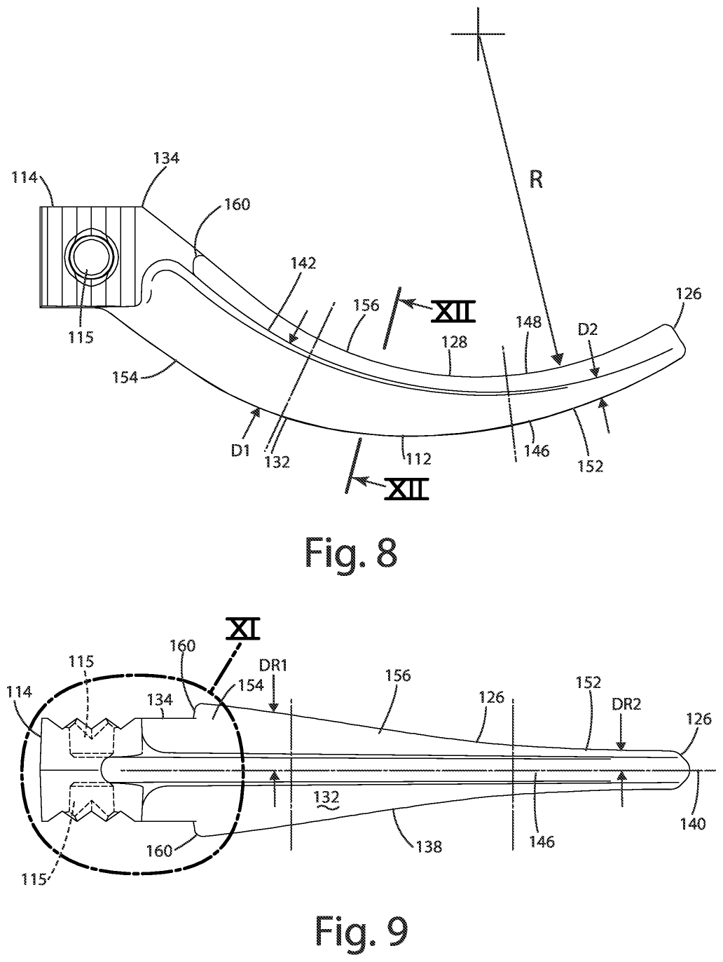

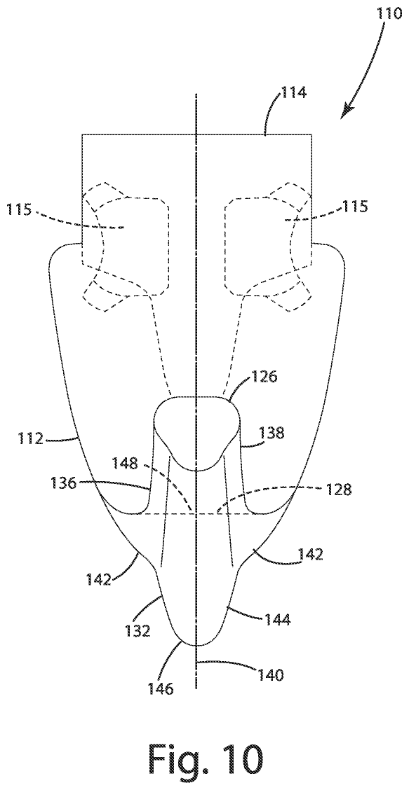

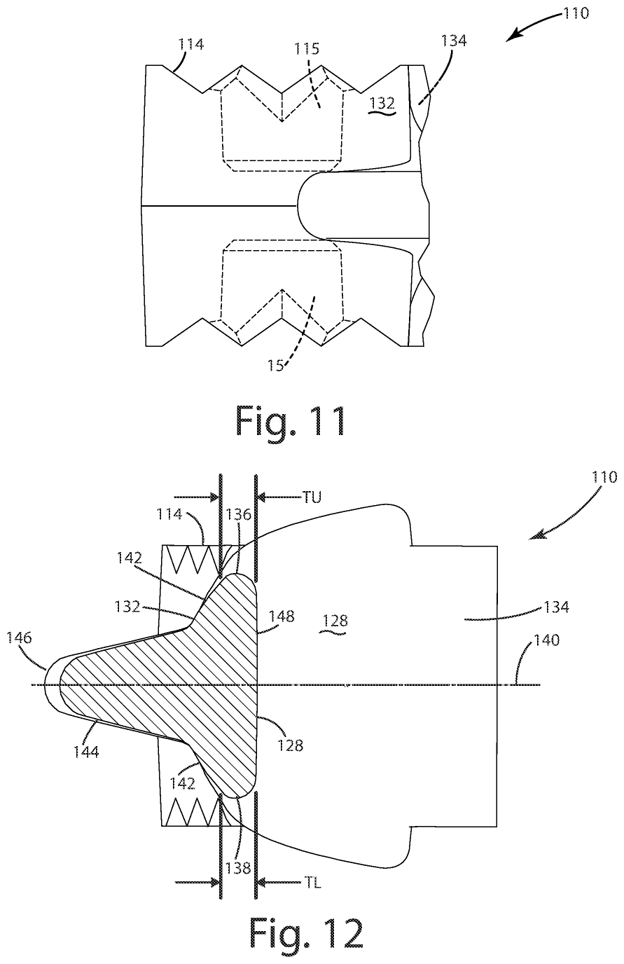

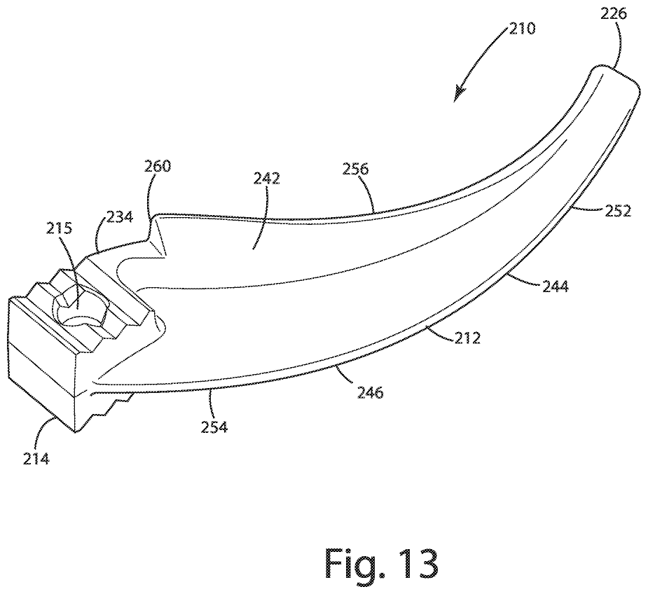

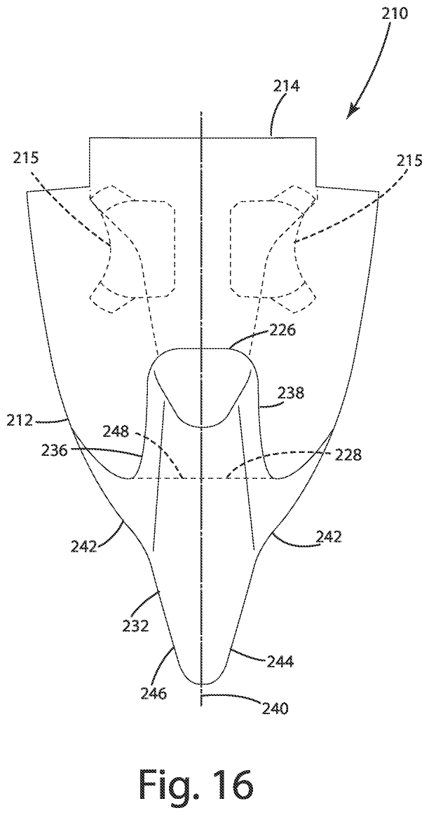

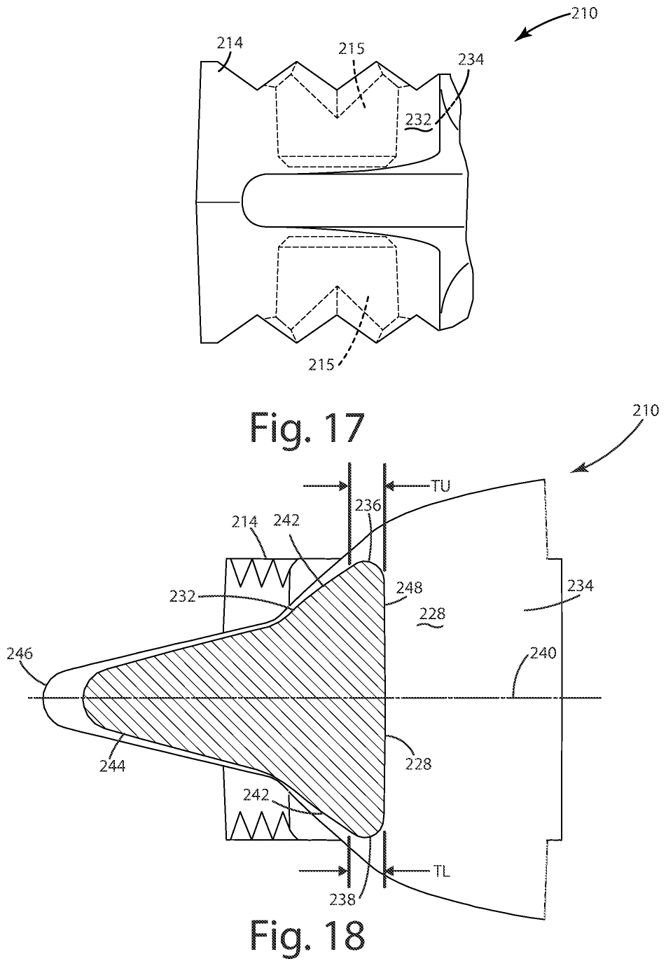

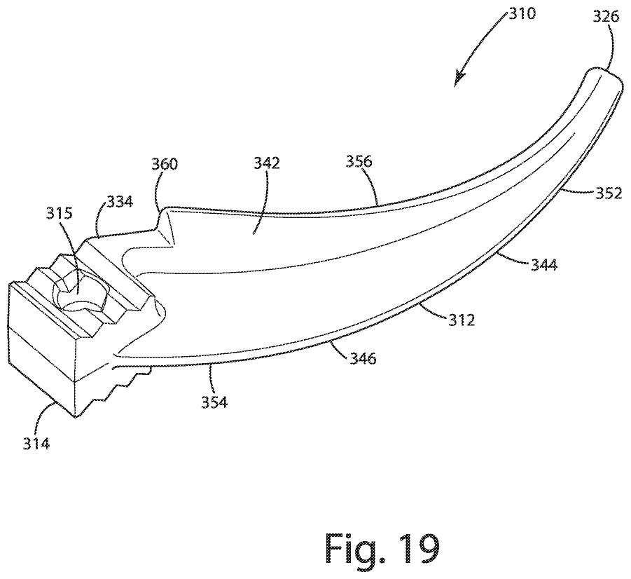

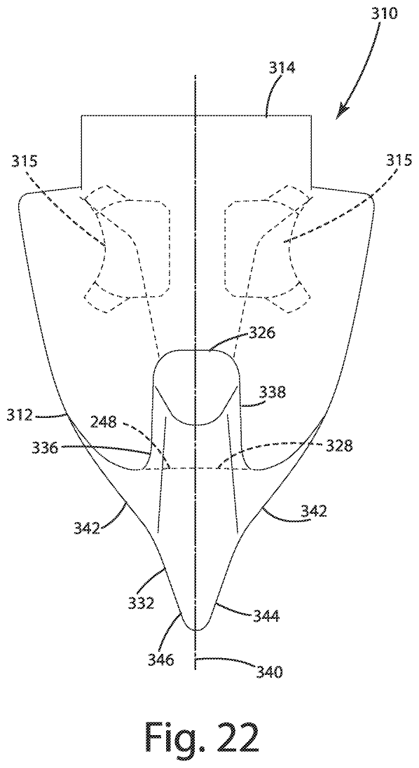

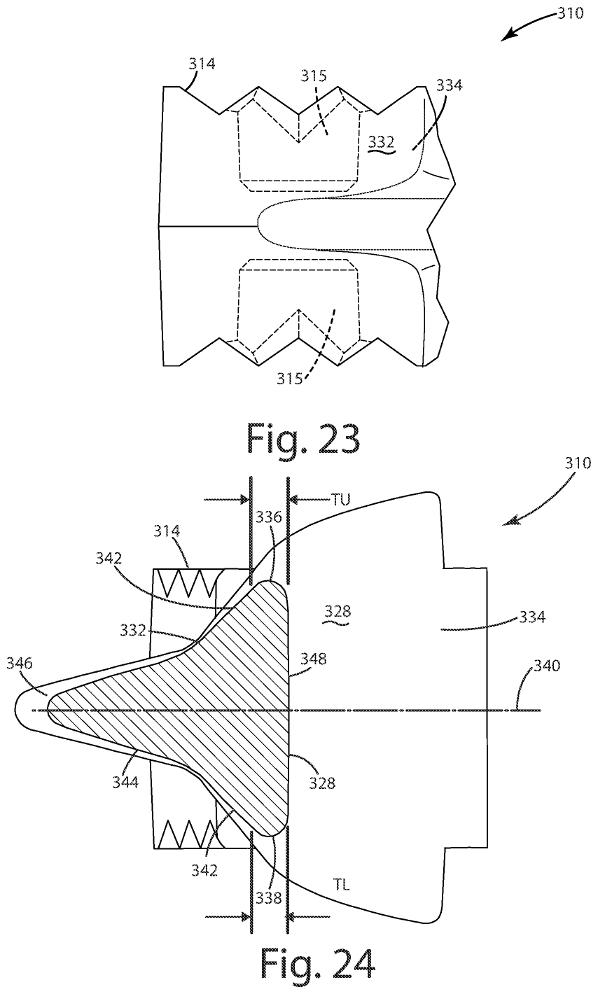

Various sizes of the dental wedge 10 in accordance with one or more embodiments described herein are provided in the illustrated embodiments of FIGS. 7-24, and are respectively designated 100, 200, 300. The dental wedges 10, 100, 200, 300 are provided in different sizes largely to accommodate various size teeth and gaps between teeth. The dental wedges 100, 200, 300 are configured similarly to the dental wedge 10 with the proportion and arrangement of components varied in accordance with the respective size of each dental wedge 100, 200, 300. For purposes of disclosure, components of the dental wedges 100, 200, 300 are designated with a reference number with the first two digits corresponding to the counterpart component of the dental wedge 10. For instance, component 12 of the dental wedge 10 corresponds to component 112 of the dental wedge 100, with an arrangement and structure commensurate with the target size of the dental wedge 100. It is noted that some components of the dental wedges 100, 200, 300 may remain substantially the same size as the counterpart component of the dental wedge 10, such as a head portion 114 being a similar in construction and size to the head portion 14. On the other hand, another component of the dental wedges 100, 200, 300 may increase with respect to one or more dimensions thereof based on the target size of the dental wedge 100, 200, 300. For instance, the height of the ridge 346 of the dental wedge 300 is greater than the height of the ridge 46 of the dental wedge 10.

In the illustrated embodiments of FIGS. 1-6, the dental wedge 10 includes an elongate body 12 and a head portion 14 attached to the elongate body 12. The head portion 14 may be grasped by a tool to facilitate placement and removal of the dental wedge 10. For instance, forceps may be used to grasp the head portion 14 and insert the elongate body 12 between adjacent teeth to force a matrix band into contact with a working tooth of the adjacent teeth. For purposes of disclosure, the working tooth is the tooth being prepared and filled by the dentist.

The head portion 14 in the illustrated embodiment includes depressions 15 configured to receive a tool to facilitate grasping as well as insertion and removal of the dental wedge 10.

The elongate body 12 may be made from a variety of materials, depending on the application. For instance, the elongate body 12 may be made of a single material, such as a plastic material. As another example, the elongate body 12 may include a core formed with a first material and an over molded outer surface formed from a second material that is softer than the first material, such as a thermal plastic elastomer (TPE). Additional examples are described in U.S. Pat. No. 7,223,101, entitled WEDGE FOR USE IN DENTAL RESTORATION, issued May 29, 2007, to Garrison et al. —the disclosure of which is hereby incorporated by reference in its entirety.

The elongate body 12, in one embodiment, may be manufactured by molding (e.g., injection molding) the one or more materials selected to form the elongate body 12. The head portion 14 may be made of the same material or materials as the elongate body 12. Alternatively, the head portion 14 may be made of a material different from the elongate body 12. The head portion 14 may be manufactured as part of the same process (e.g., molding) used to manufacture the elongate body 12. For instance, the head portion 14 may be made of the same material as the elongate body 12, and may be molded at the same time as the elongate body 12 and integral with the elongate body 12.

In the illustrated embodiment, the elongate body 12 includes a distal end 26 and a proximal end 34. The elongate body 12 may taper from the proximal end 34 to the distal end 26, with the distal end 26 corresponding to an insertion end for inserting into an interproximal area between a working tooth and an adjacent tooth to support the matrix band in position against the working tooth. For purposes of disclosure, the elongate body 12 is discussed in conjunction with three regions or portions, with a first portion 52 including the distal end 26, a second portion 54 including the proximal end 34, and an intermediate portion 56 being between the first and second portions 52, 54. In one embodiment, the boundary between portions 52, 54, 56 may be seamless such that there is no distinct difference between adjacent portions. In an alternative embodiment, the boundary may be identifiable by a difference in one or more properties, such as a difference in shape (e.g., curvature) or material construction, or any combination thereof. For instance, the second portion 54 including the proximal end 34 may include less taper than the intermediate portion 56 adjacent to the second portion 54.

Referring to FIGS. 1-6, elongate body 12 includes an inside surface 28 that extends from the proximal end 34 to the distal end 26, or along the first, second, and intermediate portions 52, 54, 56. The elongate body 12 also includes an outside surface 32 that is opposite the inside surface 28, and that extends from the distal end 26 to the proximal end 34, or along the first, second, and intermediate portions 52, 54, 56. The inside surface 28 joins the outside surface 32 respectively at an upper portion 36 and a lower portion 38 of the elongate body 12, both of which extend from the proximal end 34 to the distal end 26 of the elongate body 12. The upper portion 36 and the lower portion 38 of the elongate body 12 may be rounded as depicted in the illustrated embodiment—however, it is to be understood that the upper and lower portions 36, 38 may be shaped in a variety of ways, including for example being defined as edges at which the inside surface 28 joins the outside surface 32.

As described herein, the elongate body 12 may be used in a left hand configuration and a right hand configuration. For purposes of disclosure, the upper and lower portions 36, 38, as well as the inside and outside surfaces 28, 32, are described in conjunction with a right hand configuration in which the elongate body 12 is disposed to the right of the working tooth. It is to be understood that, for the left hand configuration, the elongate body 12 is rotated 180° relative to the illustrated embodiments with the upper portion 36 being below the lower portion 38, and the inside surface 28 disposed to the left of the working tooth.

In one embodiment, the elongate body 12 may be substantially symmetrical with respect to a plane 40 that is normal to the inside surface 28 and intersects a midpoint of the inside surface 28 between the upper and lower portions 36, 38. This way, operability of the dental wedge 10 in interfacing with the working tooth, the matrix band, and the gum tissue of the working tooth is the same for both the left and right hand uses.

In the illustrated embodiment, the inside surface 28 is configured to support the matrix band in contact with a surface of the working tooth. The inside surface 28 may include a primary surface 48 between the upper portion 36 and the lower portion 38. The primary surface 48 may be curved from the distal end 26 to the proximal end 34, such that the primary surface 48 is operable to conform to the generally curved surface of the working tooth. The dental wedge 10 may be offered in a variety of sizes (e.g., dental wedges 100, 200, 300), allowing a dentist to select a dental wedge 10 that is considered to be an appropriate size for the working tooth. For instance, the dental wedge 10 may be offered in a variety of sizes with the curvature R of the primary surface 48 varying between two limits, such as a radius being between 4 mm to 8 mm. The number of sizes available between the two limits (e.g., the number of steps between 4 mm and 8 mm) may vary depending on the application. The limits may be determined based on the curvatures of the types of working teeth targeted for the dental wedge 10. The length of the dental wedge 10 may also vary between two limits, depending on the sizes of working teeth targeted for use with the dental wedge 10. For instance, the dental wedge 10 may be offered in lengths between 7 mm and 15 mm, with the dental wedges 10, 100, 200, 300 in the illustrated embodiments being about 12 mm to 13 mm in length.

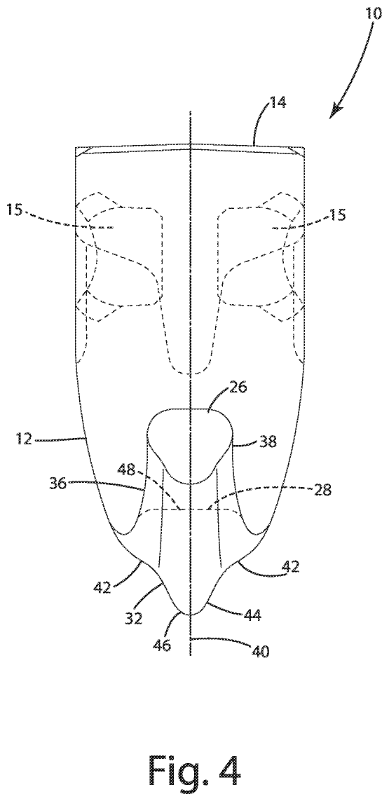

The primary surface 48 in the illustrated embodiment is substantially flat between the upper and lower portions 36, 38. The cross section of the primary surface 48 as shown in the illustrated embodiments of FIGS. 4 and 6 shows the flat aspect of the primary surface 48. As described herein, the inside surface 28 may taper from the proximal end 34 to the distal end 26. The taper may vary from application to application, including for example from 2 mm near the proximal end 34 to 0.7 mm near the distal end 26, as depicted in the illustrated embodiment of FIG. 3. The taper may vary depending on the target size of the dental wedge. For instance, the taper of the dental wedge 300 in the illustrated embodiment of FIG. 21 is from approximately 3 mm near the proximal end 34 to 0.7 mm near the distal end 26. The taper, as depicted in the illustrated embodiment of FIG. 21 may be nonlinear with the slope of the taper being greater for the second portion 354 than the first portion 352.

In the illustrated embodiment of FIG. 6, the outside surface 32 is opposite the inside surface 28 of the elongate body 12. The outside surface 32 includes a base surface 42 from which a rib 44 extends in a direction away from both the base surface 42 and the inside surface 28. The rib 44 may extend longitudinally along at least a portion of the elongate body 12. In the illustrated embodiment, the rib 44 extends from the proximal end 34 to the distal end 26 of the elongate body 12. The rib 44 may define a ridge 46 that is operable, in response to insertion of the dental wedge 10 between a working tooth and a tooth adjacent the working tooth, to contact the tooth adjacent to the working tooth to transfer force to the working tooth via the inside surface 28. The rib 44 in the illustrated embodiment is normal to the base surface 42 of the outside surface 32, defining a cross section of the elongate body 12 as having a substantially T-shaped structure.

It is to be understood that the rib 44 of elongate body 12 is a type of projection from the base surface 42 and that the elongate body 12 is not limited to having a projection in the form of a rib 44 that forms a T-shaped cross section. The elongate body 12 may include substantially any type of projection that provides a ridge 46 operable to contact the tooth adjacent the working tooth.

The ridge 46 in the illustrated embodiment includes a rounded surface to facilitate contact with the tooth adjacent the working tooth. The radius of the ridge 46 may vary depending on the application, including based on the thickness of the rib 44. It is to be understood that the shape of the ridge 46 may be different. For instance, the ridge 46 may include more than two facets or surfaces that define multiple edges or two surfaces or facets that join at a single edge that extends substantially from the proximal end 34 to the distal end 26.

The rib 44 may protrude from the base surface 42, as depicted in the illustrated embodiment, with the ridge 46 being curved from the proximal end 34 to the distal end 26. The curvature of the ridge 46 may be different from the curvature of the primary surface 48 of the inside surface 28, largely because the rib 44 may taper from the proximal end 34 to the distal end 26. For instance, the ridge 46 of the rib 44 may be disposed away from the base surface 42 near the proximal end 34 by a first distance D1, and disposed away from the base surface 42 near the distal end 26 by a second distance D2 that is less than the first distance. In the illustrated embodiment, the ridge 46 is substantially absent from the distal end 26 such that the distance between the ridge 46 and the base surface 42 near the distal end 26 is zero, whereas the first distance D1 is about 2.2 mm. The first and second distances D1, D2 may vary depending on the application. For instance, the first and second distances D1, D2 may define more or less taper or no taper from the proximal end 34 to the distal end 26. Additional example distances for the first and second distances D1, D2 are shown in conjunction with the dental wedges 100, 200, 300, and which may include: 1) D1: 1.35 mm, D2: 0 mm, 2) D1: 1.62 mm, D2: 0 mm, 3) D1: 2.1 mm, D2: 0 mm, or 4) D1: 2.7 mm, D2: 0 mm. It is to be understood that the dimension D2 may not be zero in some embodiments.

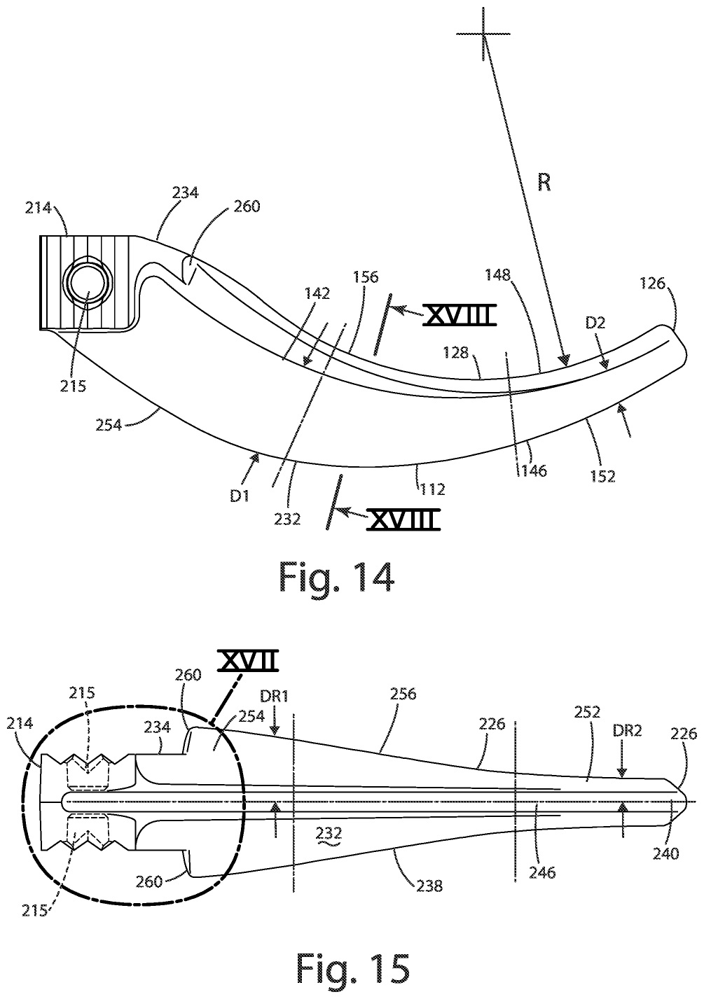

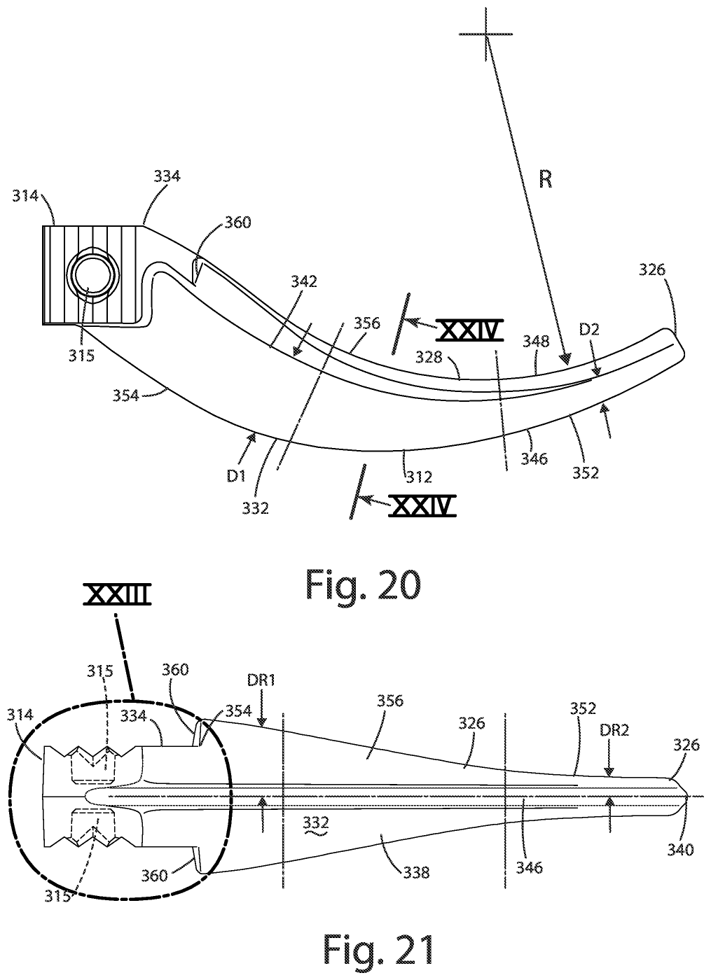

In one embodiment, as depicted in FIGS. 14 and 20, the rib 244, 344 and ridge 246, 346 may extend past the proximal end 234, 334 and form part of the head portion 214, 314. This configuration may enable a greater difference in distance between the distance D2 near the distal end 226, 326 and the distance between the base surface 242, 342 and the ridge 246, 346 (and between the inside surface 228, 328 and the ridge 246, 346).

In the illustrated embodiment of FIGS. 1-6, as described herein, the inside surface 28 may taper from the proximal end 34 to the distal end 26. The distance DR1, DR2 between the rib 44 and the upper and lower portions 36, 38 may also taper from the proximal end 34 to the distal end 26, such as from about 0.75 mm near the proximal end 34 at DR1 to about 0.5 mm near the distal end 26.

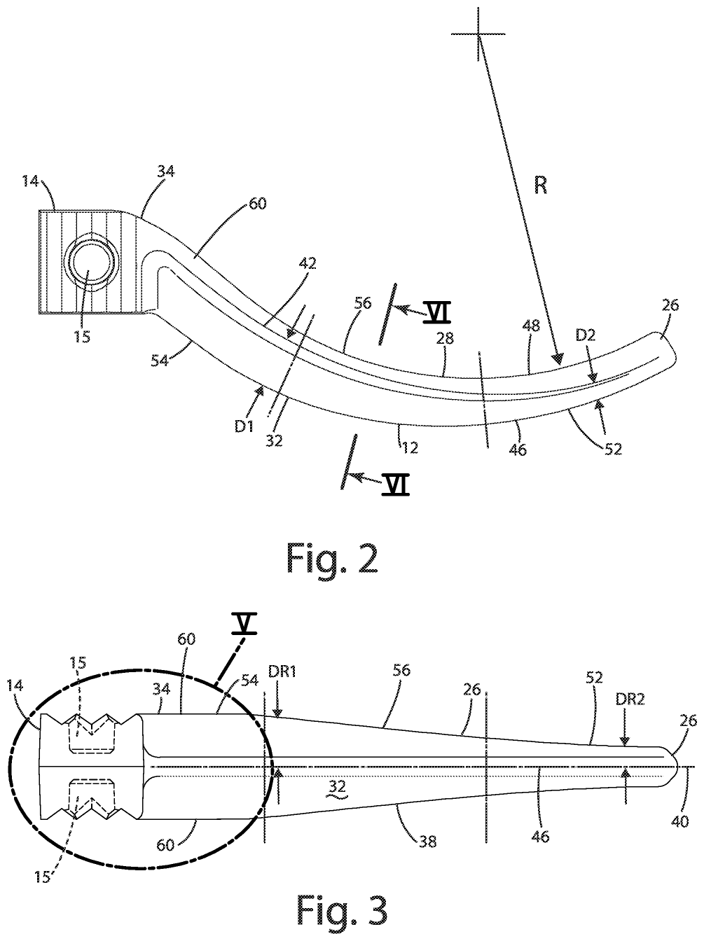

In one embodiment, the dental wedge 10 may include a keepout region 60 where the distance between the rib 44 and the upper and lower portions 36, 38 does not exceed a threshold distance. The threshold distance for the keepout region 60 in the illustrated embodiment of FIGS. 2 and 3 is approximately equal to the distance DR2, and therefore the keepout region 60 is less apparent. However, in the illustrated embodiments of FIGS. 7-24, the distance DR2 is greater than the threshold distance for the keepout region 60, 160, 260, 360, and therefore the keepout region 160, 260, 360 is more apparent.

The upper and lower portions 36, 38 in the illustrated embodiments may be rounded—although the present disclosure is not so limited such that a cross section of the upper and lower portions 36, 38 may define any type of shape and may be different for one or more of the first, second, and intermediate portions 52, 54, 56. The thickness TL, TU of the upper and lower portions 36, 38 is defined largely by the distance between the base surface 42 of the outside surface 32 and the primary surface 48 of the inside surface 28. This thickness may be sufficiently thin to allow either the upper portion 36 or the lower portion 38, depending on whether the dental wedge 10 is used in a left hand or right hand configuration, to insert between the gum tissue of the working tooth and the working tooth in response to insertion of the dental wedge 10 between the working tooth and a tooth adjacent the working tooth. Example thicknesses for TL, TU may be 0.3 mm, or 1.1 mm, or any thickness therebetween. As discussed herein, insertion of the dental wedge 10 between teeth results in horizontal displacement of the dental wedge 10 toward the gum tissue of the working tooth. The thickness and shape of the upper and lower portions 36, 38 may enable insertion between the gum tissue and the working tooth without significantly displacing the gum tissue. For instance, rather than the tetrahedral shape of conventional wedges and the wedging action that these conventional shapes impart on gum tissue in response to insertion, the upper and lower portions 36, 38 may slide between the gum tissue and the working tooth without significantly displacing the gum tissue.

In one embodiment, when the dental wedge 10 is inserted in the interproximal portion of adjacent teeth, the taper of the rib 44 along the elongate body 12 generates a separating force which separates the teeth. The taper of the inside surface 28 gradually introduces the lower portion 38 into contact with the gum tissue of the working tooth, gradually separating the gum tissue from the working tooth. The thickness TL of the lower portion 38 may be substantially uniform such that the gum tissue is separated from the working tooth by a maximum distance corresponding to the thickness TL of the lower portion 38.

Referring to FIGS. 2-3, distal end 26 comprises a generally rounded insertion end and more preferably a duckbill-shaped insertion end that has a sufficient roundness to minimize trauma to the gum tissue. In addition, distal end 26 is preferably sloped upwardly (relative to the plane 40) to further minimize or reduce the damage to the gum tissue when inserted into the interproximal area between the teeth.

Directional terms, such as vertical, horizontal, top, bottom, upper, lower, inner, inwardly, outer and outwardly, are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles a, an, the or said, is not to be construed as limiting the element to the singular. Any reference to claim elements as at least one of X, Y and Z is meant to include any one of X, Y or Z individually, and any combination of X, Y and Z, for example, X, Y, Z; X, Y; X, Z; and Y, Z.

1. A dental wedge comprising:
an elongate body having a distal end and a proximal end tapering to the distal end, the distal end defining an insertion end for inserting into an interproximal area between adjacent teeth;
the elongate body having a first portion starting at the distal end, a second portion ending at the proximal end, and an intermediate portion between the first portion and the second portion,
the elongate body having an inside surface that extends along the first, second, and intermediate portions, the elongate body having an outside surface opposite the inside surface that extends along the first, second, and intermediate portions, the inside surface configured to support a matrix band in contact with a tooth surface of a working tooth;
the outside surface including a base surface and a ridge that protrudes from the base surface away from the inside surface, the ridge extending along at least a portion of the elongate body between the distal end and the proximal end; and
wherein a cross-section of the elongate body is substantially symmetrical about a plane normal to the inside surface and intersecting the ridge, such that the elongate body is operable for left hand and right hand use.

2. The dental wedge of claim 1 wherein:
the inside surface joins the outside surface at an upper portion and a lower portion of the elongate body;
the lower portion and the upper portion extend from the distal end to the proximal end of the elongate body; and
the inside surface includes a primary surface disposed between the upper portion and the lower portion.

3. The dental wedge of claim 2 wherein the primary surface is substantially flat from the upper portion to the lower portion and curved from the distal end to the proximal end.

4. The dental wedge of claim 2 wherein the lower portion is rounded between the inside surface and the outside surface.

5. The dental wedge of claim 2 wherein a thickness of the lower portion is sufficiently thin to slide between the working tooth and gum tissue of the working tooth in response to placement of the elongate body between the working tooth and a tooth adjacent to the working tooth.

6. The dental wedge of claim 1 wherein the ridge is defined by a rib that is normal to the base surface and extends along the elongate body from the distal end to the proximal end.

7. The dental wedge of claim 6 wherein a cross-section of the intermediate portion is a substantially T-shaped structure with the rib defining a base of the substantially T-shaped structure.

8. The dental wedge of claim 1 wherein the ridge is configured to engage a tooth adjacent to the working tooth in response to insertion of the elongate body between the working tooth and the tooth adjacent to the working tooth, whereby the inside surface is operable to apply force to the matrix band in response to engagement of the ridge with the tooth adjacent to the working tooth such that the elongate body is configured to hold the matrix band in contact with the tooth surface of the working tooth.

9. The dental wedge of claim 1 comprising a head portion attached to the proximal end of the first portion, the head portion operable to be grasped by a tool to facilitate placement and removal of the dental wedge.

10. (canceled)

11. A dental wedge comprising:
an elongate body having a distal end and a proximal end tapering to the distal end, the distal end defining an insertion end for inserting into an interproximal area between adjacent teeth;
the elongate body having an inside surface and an outside surface opposite the inside surface;
the outside surface including a base surface and a protrusion that extends from the base surface away from the inside surface for at least a portion of the elongate body between the distal end and the proximal end; and
wherein a cross-section of the elongate body is substantially symmetrical about a plane normal to the inside surface and intersecting the protrusion, such that the elongate body is operable for left hand and right hand use.

12. The dental wedge of claim 11 wherein the protrusion defines a rib that is normal to the base surface and extends along the portion the elongate body between the distal end to the proximal end.

13. The dental wedge of claim 12 wherein a cross-section of the portion is a substantially T-shaped structure with the rib defining a base of the substantially T-shaped structure.

14. The dental wedge of claim 11 wherein:
the inside surface joins the outside surface at an upper portion and a lower portion of the elongate body;
the lower portion and the upper portion extend from the distal end to the proximal end of the elongate body; and
the inside surface includes a primary surface disposed between the upper portion and the lower portion.

15. The dental wedge of claim 14 wherein the primary surface is substantially flat from the upper portion to the lower portion and curved from the distal end to the proximal end.

16. The dental wedge of claim 14 wherein the lower portion is rounded between the inside surface and the outside surface.

17. The dental wedge of claim 14 wherein a thickness of the lower portion is sufficiently thin to slide between a working tooth and gum tissue of the working tooth in response to placement of the elongate body between the working tooth and a tooth adjacent to the working tooth.

18. A dental wedge comprising:
an elongate body having a distal end and a proximal end tapering to the distal end, the distal end defining an insertion end for inserting into an interproximal area between adjacent teeth;
the elongate body having an inside surface and an outside surface opposite the inside surface;
the elongate body having an upper portion and a lower portion extending from the distal end to the proximal end, the inside surface joining the outside surface at the upper portion and the lower portion;
the inside surface including a primary surface disposed between the upper portion and the lower portion;
the outside surface including a base surface and a rib that extends from the base surface away from the inside surface for at least a portion of the elongate body between the distal end and the proximal end;
the upper portion and the lower portion having a thickness sufficiently thin to slide between a working tooth and gum tissue of the working tooth in response to placement of the elongate body between the working tooth and a tooth adjacent to the working tooth; and
wherein a cross-section of the elongate body is substantially symmetrical about a plane normal to the inside surface and intersecting the rib, such that the elongate body is operable for left hand and right hand use.

19. The dental wedge of claim 18 wherein the elongate body is tapered between the upper portion and the lower portion from the proximal end to the distal end.

20. The dental wedge of claim 18 wherein the rib is normal to the base surface such that a cross-section of the portion is a substantially T-shaped structure with the rib defining a base of the substantially T-shaped structure.
